(19) United States
(12) Patent Application Publication
(10) Pub. No.: US 2015/0047522 A1
(43) Pub. Date: Feb. 19, 2015

(54) Stamp-Making Methods and Devices

(71) Applicant: Crayola LLC, Easton, PA (US)

(72) Inventors: Craig John Skinner, Nazareth, PA (US); Luis Rodrigo Pineiro, Bethlehem, PA (US)

(21) Appl. No.: 14/457,322

(22) Filed: Aug. 12, 2014

Related U.S. Application Data
(60) Provisional application No. 61/865,393, filed on Aug. 13, 2013.

(51) Int. Cl. B41C 1/10

(52) U.S. Cl. CPC B41C 1/1008
USPC 101/401.1

(57) ABSTRACT

Methods and devices for making a handheld stamp are provided. In one aspect, a stamp image is applied to a photosensitive and/or photo-reactive stamp surface that, when exposed to light having a particular wavelength for a particular amount of time, produces a handheld stamp. The photosensitive stamp surface may be a photosensitive foam, a photosensitive gel, and the like. In another embodiment, a rub-on transfer image is applied to a surface of a porous plastic sheet, where the applied rub-on transfer image prohibits the flow of ink through portions of the porous plastic sheet. In another embodiment, a transparency masks a portion of a photosensitive transfer material during light treatment to produce a stamp mask. The stamp mask is then applied to a porous plastic stamping material to produce a handheld stamp.

### CROSS-REFERENCE TO RELATED APPLICATIONS

This application claims priority to U.S. Provisional Application Ser. No. 61/865,393, filed Aug. 13, 2013, entitled “Stamp-Making Methods and Devices,” the disclosure of which is hereby incorporated by reference in its entirety.

### SUMMARY

Aspects of the disclosure are defined by the claims below, not this summary. A high-level overview of various features are provided here for that reason, to provide an overview of the disclosure, and to introduce a selection of concepts that are further described in the detailed description section below. This summary is not intended to identify key features or essential features of the claimed subject matter, nor is it intended to be used as an aid in isolation to determine the scope of the claimed subject matter.

In brief and at a high level, this disclosure describes, among other things, methods and devices for making a handheld stamp. In particular, one aspect of the disclosure is directed to applying a stamp image to a photosensitive and/or photo-reactive stamp surface that, when exposed to light having a particular wavelength for a particular amount of time, produces a handheld stamp. The photosensitive stamp surface may be a photosensitive foam, a photosensitive gel, and the like. In other aspects, a rub-on transfer image is applied to a surface of a porous plastic sheet, where the applied rub-on transfer image prohibits the flow of ink through portions of the porous plastic sheet. In another aspect, a transparency masks a portion of a photosensitive transfer material during light treatment to produce a stamp mask. The stamp mask is then applied to a porous plastic stamping material to produce a handheld stamp.

### DESCRIPTION OF THE DRAWINGS

Illustrative embodiments of the invention are described in detail below with reference to the attached drawing figures, and wherein:

FIG. 1 is a front, perspective view of a stamp image for making a handheld stamp, in accordance with aspects of the disclosure;

FIG. 2 is a front, perspective view of the stamp image of FIG. 1 applied to a photosensitive stamp surface and positioned relative to a light-emitting device in an open position, in accordance with an aspect of the disclosure;

FIG. 3A is a front, perspective view of a light-emitting device in a closed position, in accordance with an aspect of the disclosure;

FIG. 3B is a perspective view of a light-emitting device in a closed position, with a portion of the device cut away to reveal a light source, in accordance with an aspect of the disclosure;

FIG. 4 is a front, perspective view of a light-emitting device in an open position, having exposed the photosensitive stamp surface to light, in accordance with an aspect of the disclosure;

FIG. 5 is a front, perspective view of handheld stamp for assembly, created using a light-emitting device to treat the photosensitive stamp surface, in accordance with an aspect of the disclosure;

FIG. 6A is a front, perspective view of an assembled, handheld stamp marking on a writing surface, in accordance with an aspect of the disclosure;

FIG. 6B is a front, perspective view of an assembled, handheld stamp having marked on the writing surface of FIG. 6A, in accordance with an aspect of the disclosure;

FIG. 7A is a front, perspective view of a rub-on transfer image being applied to a porous plastic surface, in accordance with an aspect of the disclosure;

FIG. 7B is a front, perspective view of the rub-on transfer of FIG. 7A applied to a the porous plastic surface, in accordance with an aspect of the disclosure;

FIG. 7C is a front, perspective view of a marking instrument applying a manual mask to the surface of a porous stamp surface, in accordance with aspects of the disclosure;

FIG. 8A is a front, perspective view of a transparency masking a photosensitive transfer material, in accordance aspects of the disclosure;

FIG. 8B is a front, perspective view of a photosensitive transfer material with a portion of the photosensitive transfer material removed, in accordance with aspects of the disclosure;

FIG. 8C is a front, perspective view of the photosensitive transfer material of FIG. 8B applied to a porous plastic stamping material, in accordance with aspects of the disclosure;

FIG. 8D is a top view of a paper surface stamped with the porous plastic stamping material, in accordance with an aspect of the disclosure; and

FIG. 8E is a front, perspective view of a porous plastic stamping material with a plurality of stamp masking stickers, in accordance with aspects of the disclosure.

### DETAILED DESCRIPTION

The subject matter of select embodiments of the invention is described with specificity herein to meet statutory requirements. But the description itself is not intended to necessarily limit the scope of claims. Rather, the claimed subject matter might be embodied in other ways to include different components, steps, or combinations thereof similar to the ones described in this document, in conjunction with other present or future technologies. Terms should not be interpreted as implying any particular order among or between various steps herein disclosed unless and except when the order of individual steps is explicitly described.

Methods and devices are described herein for accurately producing a handheld stamp. In particular, one aspect of the disclosure is directed to applying a stamp image to a photosensitive and/or photo-reactive stamp surface that, when exposed to light having a particular wavelength for a particular amount of time, produces a handheld stamp. The photosensitive stamp surface may be a photosensitive foam, a photosensitive gel, and the like. In another aspect, a rub-on transfer image is applied to a surface of a porous plastic sheet, where the applied rub-on transfer image prohibits the flow of ink through portions of the porous plastic sheet. In further aspects, a transparency masks a portion of a photosensitive transfer material during light treatment to produce a stamp mask. The stamp mask is then applied to a porous plastic stamping material to produce a handheld stamp.

Accordingly, one exemplary aspect of the invention includes a method of producing a handheld stamp. The method includes applying a stamp image mask to a photosensitive stamp surface to provide a masked portion of the photosensitive stamp surface and an unmasked portion of the photosensitive stamp surface; exposing the unmasked portion of the photosensitive stamp surface to light having a particular wavelength for a particular amount of time to provide a cured portion of the photosensitive stamp surface; assembling the photosensitive stamp surface into a stamp housing comprising an ink solution; and applying the ink solution to the photosensitive stamp surface to provide a handheld stamp configured to mark a stamp image corresponding to the masked portion of the photosensitive stamp surface.

A further aspect of the invention is directed to a handheld stamp. The handheld stamp includes a porous plastic sheet having a first surface and a second surface; and a rub-on transfer image for application to the first surface of the porous plastic sheet, wherein application of the rub-on transfer image to the first surface of the porous plastic sheet provides a masked portion of the porous plastic sheet and an unmasked portion of the porous plastic sheet, wherein the unmasked portion of the porous plastic sheet permits the flow of an ink solution through the porous plastic sheet, and further wherein the handheld stamp is configured to stamp an image corresponding to the unmasked portion of the porous plastic sheet based on application of the ink solution traveling from the second surface of the porous plastic sheet to the first surface of the porous plastic sheet.

In another aspect of the invention, a method of making a handheld stamp includes applying a transparency mask to a photosensitive transfer material to provide a masked portion of a photosensitive transfer material and an unmasked portion of a photosensitive transfer material; exposing the unmasked portion of the photosensitive transfer material to light to produce a stamp mask, wherein at least a portion of the masked portion of the photosensitive transfer material is removed from the stamp mask; and applying the stamp mask to a porous plastic stamping material to produce a handheld stamp, wherein the handheld stamp is configured to reproduce an image corresponding to the masked portion of the photosensitive transfer material removed from the stamp mask.

In some aspects of the disclosure, a method of producing a handheld stamp is provided. In some aspects, a stamp image mask is applied to a top surface of a photosensitive stamp surface to provide a masked portion of the photosensitive stamp surface and an unmasked portion of the photosensitive stamp surface. In further aspects, the method includes exposing the unmasked portion of the photosensitive stamp surface to light having a particular wavelength for a particular amount of time to provide a cured portion of the photosensitive stamp surface corresponding to the unmasked portion. Further aspects of the method include assembling the photosensitive stamp surface into a stamp housing comprising an ink reservoir; and applying an ink solution from the ink reservoir to the photosensitive stamp surface to provide a handheld stamp configured to mark a stamp image corresponding to the masked portion of the photosensitive stamp surface.

In another aspect of the disclosure, a handheld stamp includes a porous plastic sheet having a first surface and a second surface; and a rub-on transfer image for application to the first surface of the porous plastic sheet. In some aspects, application of the rub-on transfer image to the first surface of the porous plastic sheet provides a masked portion of the porous plastic sheet and an unmasked portion of the porous plastic sheet, wherein the unmasked portion of the porous plastic sheet permits a flow of an ink solution through the porous plastic sheet. Additionally, in further examples, the handheld stamp is configured to stamp an image corresponding to the unmasked portion of the porous plastic sheet based on application of the ink solution traveling from the second surface of the porous plastic sheet to the first surface of the porous plastic sheet.

In a further aspect of the disclosure, a method of making a handheld stamp is provided. The method includes: applying a transparency mask to a photosensitive transfer material to provide a masked portion of a photosensitive transfer material and an unmasked portion of a photosensitive transfer material; exposing the unmasked portion of the photosensitive transfer material to light for a threshold amount of time; removing at least a portion of the masked portion of the photosensitive transfer material from the photosensitive transfer material to produce a stamp mask; and applying the stamp mask to a porous stamping material to produce a handheld stamp, wherein the handheld stamp is configured to reproduce an image corresponding to the masked portion of the photosensitive transfer material removed from the stamp mask.

With reference now to the figures, stamp-making methods and devices are described in accordance with embodiments of the invention. Various embodiments are described with respect to the figures in which like elements are depicted with like reference numerals.

### Photosensitive Stamp-Making Method

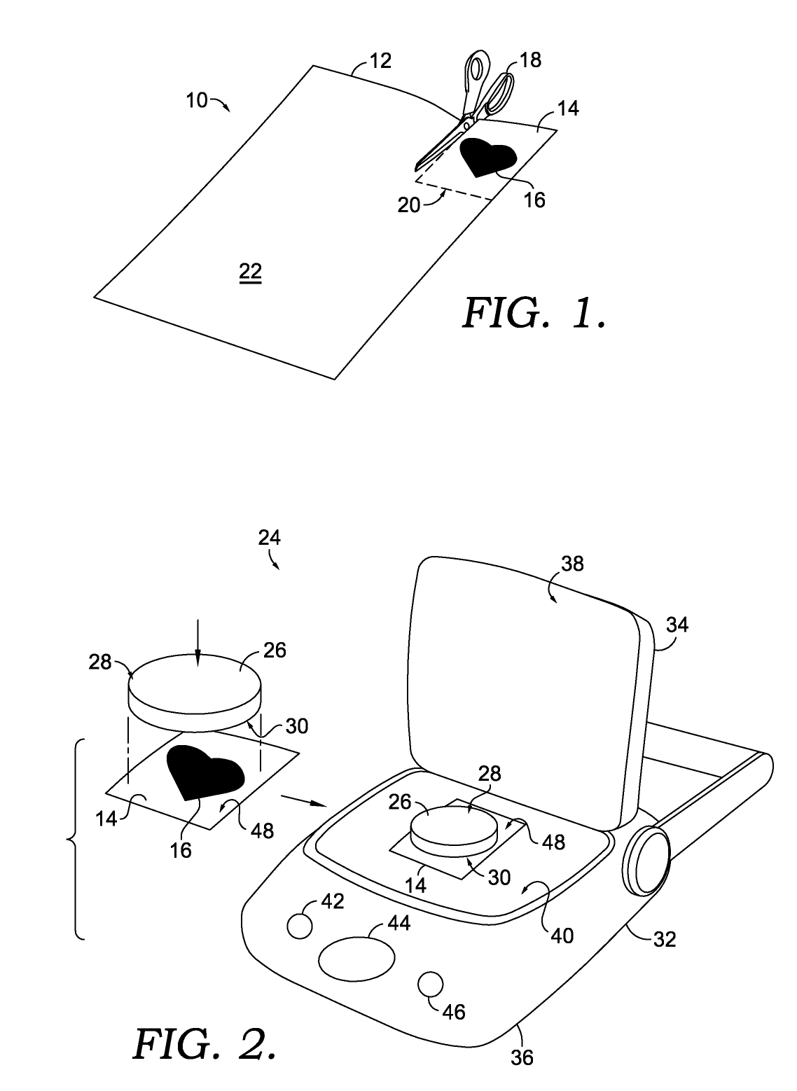

With reference initially to FIGS. 1-6B, in one aspect of the invention, a method of making a handheld stamp includes masking a first portion of a photosensitive stamp surface with a stamp image and treating the unmasked portion of a photosensitive stamp surface with a particular wavelength of light for a particular duration of time. In embodiments, the exposed, unmasked portions of the photosensitive stamp surface, such as a photosensitive porous foam, receives treatment from a light-emitting device and becomes “cured” such that the exposed pores of the photosensitive stamp surface prohibit the flow of ink through the photosensitive stamp surface (because the exposed pores are now closed). Accordingly, the unexposed pores of the photosensitive stamp surface (i.e., those masked by the stamp image) remain open and permit the flow of ink, producing a handheld stamp image on the photosensitive stamp surface. In one embodiment, the light-emitting device exposes the exposed portions of the photosensitive stamp surface to light produced, at least in part, by Xenon flash tubes.

In another embodiment, a photosensitive stamp surface, such as a photosensitive gel, is masked by a stamp image and exposed to light. After light exposure, the unexposed portions of the photosensitive stamp surface (i.e., photosensitive gel) are washed away and/or removed, while the exposed areas of the photosensitive gel are hardened and/or cured to form the handheld stamp. In one embodiment, the photosensitive gel is exposed to low-intensity blue light including at least a portion of longwave UV light.

As shown in the example 10 of FIG. 1, a stamp image 16 may be cut out from a drawing surface 12, which may be a transparency or other surface such as a piece of paper. In embodiments, the stamp image 16 is an image on a transparent and/or plastic sheet (e.g., a “transparency”) that permits light to flow through the sheet where the stamp image is not blocking the light. As such, in one aspect, a user may print, emboss, and/or mark a stamp image 16 onto the top surface 22 of drawing surface 12. A user may then use scissors 18 to cut along a border 20 of the drawing surface 12 to create an extracted portion 14 of the drawing surface 12. As such, the extracted portion 14 includes, at least, the stamp image 16, and in some aspects, at least a portion of a transparent portion of the surrounding drawing sheet 12.

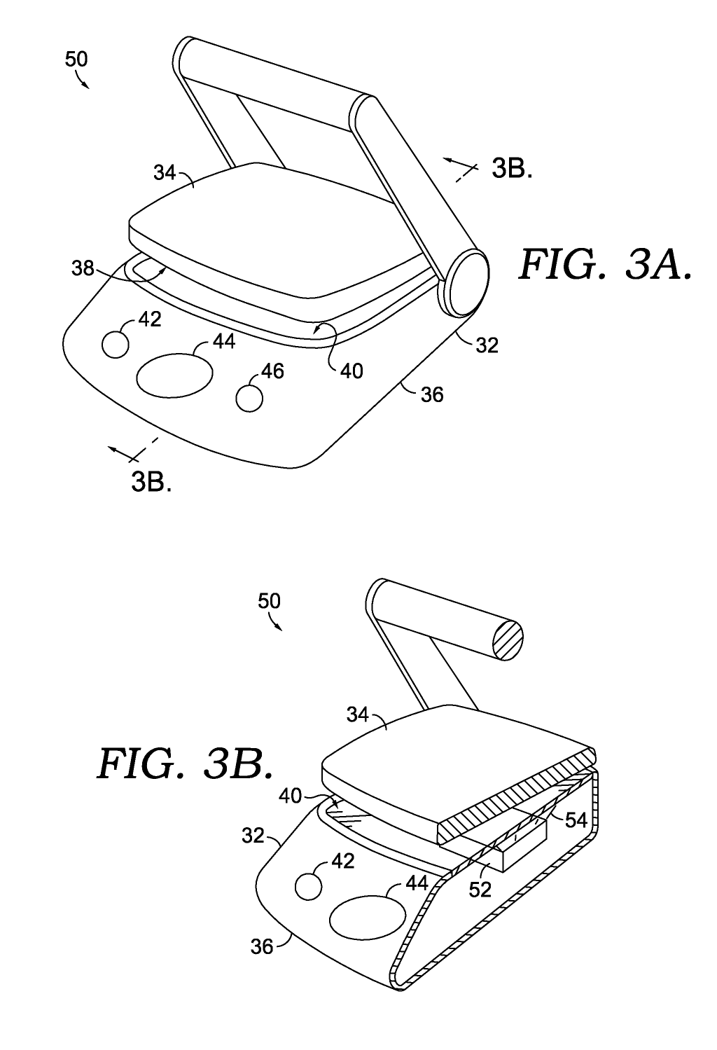

In some aspects, the stamp image 16 is applied to a photosensitive stamp surface 30 of a photosensitive stamp body 26, as shown in the example 24 of FIG. 2, and positioned relative to a light-emitting device 32 in an open position. As such, in some aspects, the extracted portion 14 includes the stamp image 16 and at least a portion of a transparent portion 48, as removed from the top surface 22 of the drawing surface 12. In some aspects, the photosensitive stamp body 26 includes both a front photosensitive stamp surface 30 (e.g., a front surface) and a back photosensitive stamp surface 28 (e.g., a back surface). As shown in FIG. 2, the photosensitive stamp surface 30 overlaid with the extracted portion 14, having both stamp image 16 and transparent portion 48, and placed on top of the bottom surface 40 of the light-emitting device 32. In the example of FIG. 2, the light-emitting device 32 includes at least a top portion 34 and a bottom portion 36. In some aspects, the top portion 34 includes a top surface 38 configured to cover and/or contact at least a portion of the back surface 28 of the photosensitive stamp body 26. Additionally, the bottom surface 40 of the light-emitting device 32 is configured to contact the extracted portion 24 adjacent the front surface 30 of the photosensitive stamp body 26.

In further aspects, the light-emitting device 32 may include one or more controls and/or features for interaction with the light-device 32, such as one or more controls and/or features associated with the control indicators 42, 44, and 46. Further, upon activation of one or more of the control indicators 42, 44, and 46, the light-emitting device 32 may begin to emit light having a particular wavelength, for a particular amount of time. As such, upon activation of one or more of the control indicators 42, 44, and 46, light may be emitted by the light-emitting device 32, through the transparent bottom surface 40, and onto the exposed surfaces of the front surface 30 of the photosensitive stamp body 26 (i.e., those portions of the photosensitive stamp body 26 that are not blocked by the stamp image 16).

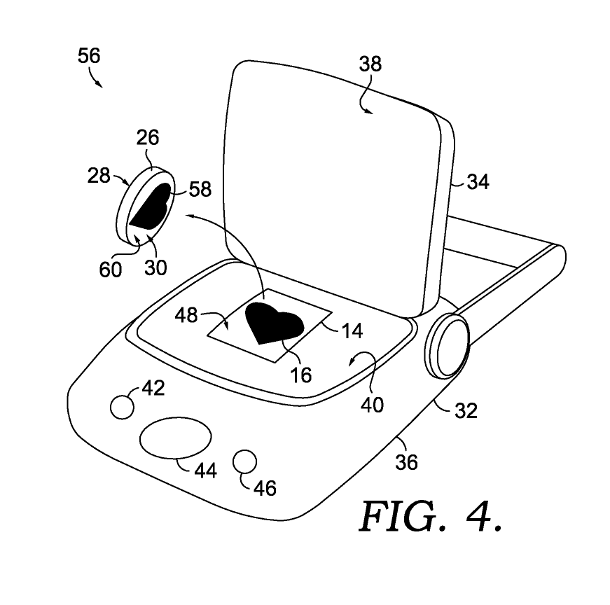

Upon closing the light-emitting device 32 in the example 50 of FIG. 3A, the unmasked portions of the photosensitive stamp surface 30 (i.e., front surface) are treated with light. For example, those portions of the front surface 30 contacted by the transparent portions 48 may be exposed to light, while those portions of the front surface 30 in contact with, adjacent to, and/or blocked by the stamp image 16 are not exposed to light. In one embodiment, the light-emitting device 32 exposes the photosensitive stamp body 26 to light from Xenon flash tubes that close the exposed pores of a photosensitive porous foam (i.e., the exposed pores of the photosensitive stamp surface 30). In another embodiment, the photosensitive stamp body 26 made from photosensitive porous foam is exposed to a low-energy, blue/violet/white LED for an extended duration of time such that the exposed pores of the photosensitive porous foam are closed and/or cured to prohibit the flow of ink and generate the handheld stamp image with respect to the unexposed/open pores. In one example, the photosensitive porous foam, masked with the stamp image 16, is exposed to a lower energy blue/violet/white LED. As such, as shown in FIG. 3B, one or more light sources 52 housed within the bottom portion 36 of the light-emitting device 32 may shine a threshold amount of light 54 through the bottom surface 40 to “cure” the exposed portions of the photosensitive stamp body 26.

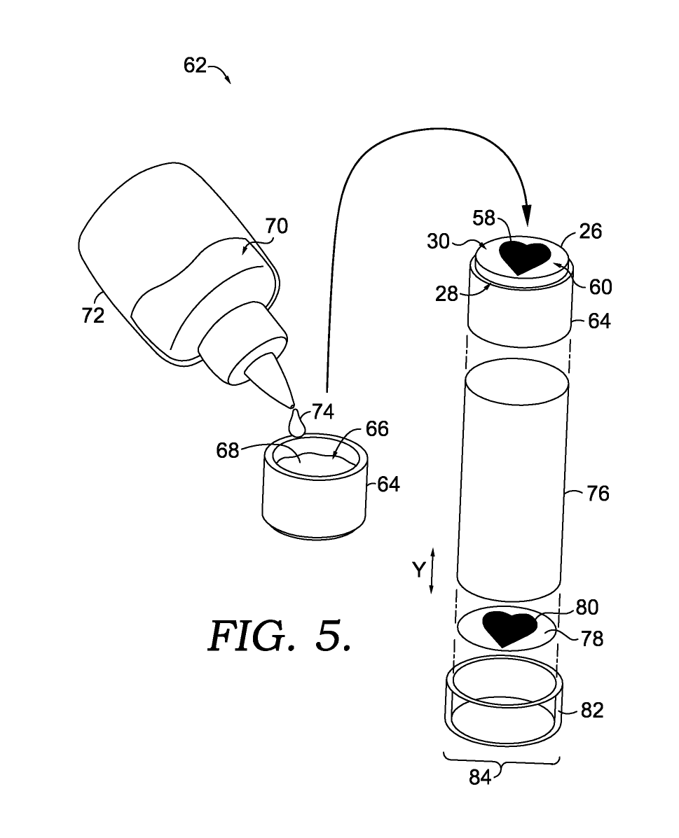

In the example 56 of FIG. 4, the light-emitting device is opened to reveal an exposed photosensitive stamp surface 30, having a “cured” portion 60 associated with the stamp image 16 (i.e., that portion of the photosensitive stamp surface that was exposed to light based on light traveling through the extracted portion 14 of the transparency, around the masking stamp image 16) and an “uncured” portion 58 of the stamp image 16 (i.e., the portion of the transparency corresponding to the stamp image 16—the heart).

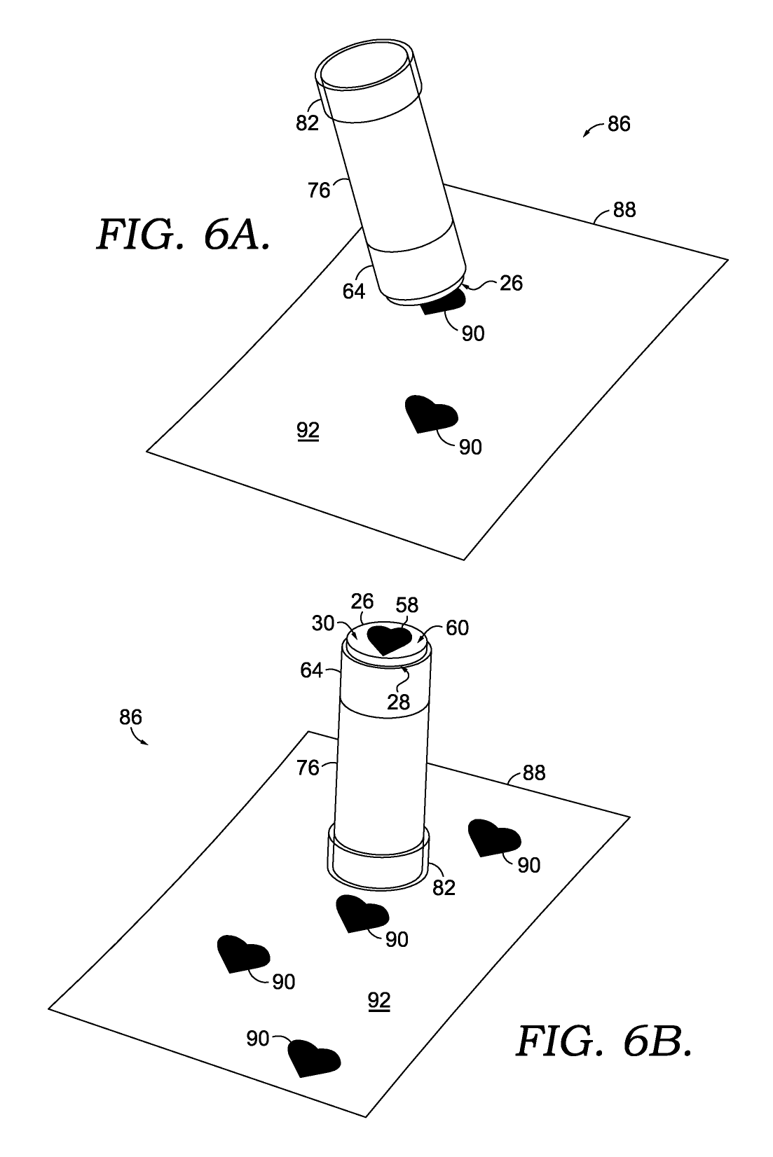

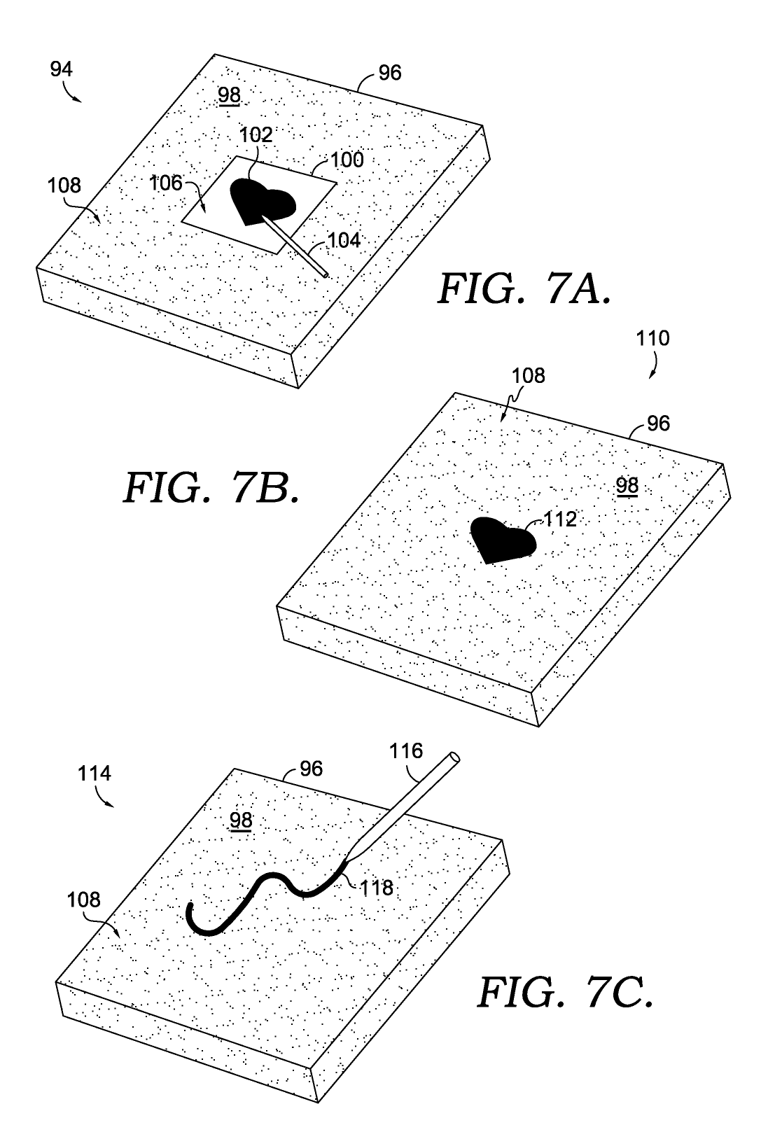

As such, the exposed photosensitive stamp surface 30 is used to assemble a handheld stamp in the example 62 of FIG. 5. In some aspects, as shown in FIG. 5, an ink solution 70 from an ink reservoir 72 may be applied to a back surface 28 of the exposed photosensitive stamp 68 (i.e., the stamp 68), and assembled as part of a stamping tool 84 for marking an impression of the stamp 68 on a marking surface 88, as shown in FIG. 6. In one aspect, an amount of ink solution 66 contacting the stamp 68, and enclosed within an upper housing 64 of a stamping tool 84, flows through the uncured portion 58 of the photosensitive stamp surface (i.e., the heart of stamp image 16) to produce a stamped image on a marking surface 88, such as a paper surface 92.

In further aspects, a back surface 28 of the stamp 68 remains in contact with the ink solution 66, while the front surface 30 is exposed for stamping. Further, in some aspects, the upper housing 64 may be coupled to a middle housing 76 (e.g., a housing used as a holder to secure the stamping tool 84) and a lower housing 82, which mates to a portion of the middle housing 76. In some aspects, the lower housing 82 is configured to secure a stamp image label 78 having a corresponding print image 80 indicating the stamping image associated with the stamp 68. In the example of FIG. 5, the hear-shaped, uncured portion 58 of the stamp 68 corresponds to the heart-shaped print image 80 of the circular stamp image label 78.

As shown in the example 86 of FIG. 6A, a photosensitive stamp body 26 (i.e., having now become “stamp” 68, with cured and uncured portions) may be contacted against a marking surface 88, such as a paper surface 92, for stamping. In some aspects, as shown in FIG. 6B, the reservoir of ink solution 66 contacting the stamp 68 provides enough ink solution 70 to ink repeated images 90 corresponding to the uncured portion 58 (i.e., the stamp image 16).

### Rub-On Transfer for Porous Plastic Sheet

In another aspect, a rub-on transfer image may be applied to a surface of a porous plastic sheet, where the applied rub-on transfer image prohibits the flow of ink through portions of the porous plastic sheet to produce a handheld stamp. In embodiments, the porous plastic sheet may be any plastic sheet having any thickness that permits the flow of ink through the surface of the sheet that is not treated by the rub-on transfer image. In one embodiment, a rub-on transfer is created by a user and applied to a surface of a porous plastic sheet. The areas of the porous plastic sheet where the transfer is applied prohibit the flow of ink through the porous plastic sheet. In one embodiment, the application of a rub-on transfer image to the surface of the porous plastic sheet is permanent, while in other embodiments, the rub-on transfer image is removable from the surface of the porous plastic sheet such that multiple different handheld stamps may be made from the same porous plastic sheet.

Accordingly, in some embodiments, the areas of the porous plastic sheet not covered by the transfer permit ink to transfer from the back surface of the porous plastic sheet, through the sheet and out of the front surface of the porous plastic sheet. In embodiments, the rub-on transfer image applied to the surface of the porous plastic sheet serves as a physical block to the transfer of ink from a first surface (e.g., the back) of the porous plastic sheet to a second surface (e.g., the front) of the porous plastic sheet, thereby creating a handheld stamp image for reproducing on a drawing surface by stamping the second/front surface of the porous plastic sheet. In embodiments, after application of the rub-on transfer image to the front surface of the porous plastic sheet, the handheld stamp image provided by the rub-on transfer image is reproduced based on an ink solution associated with the porous plastic sheet.

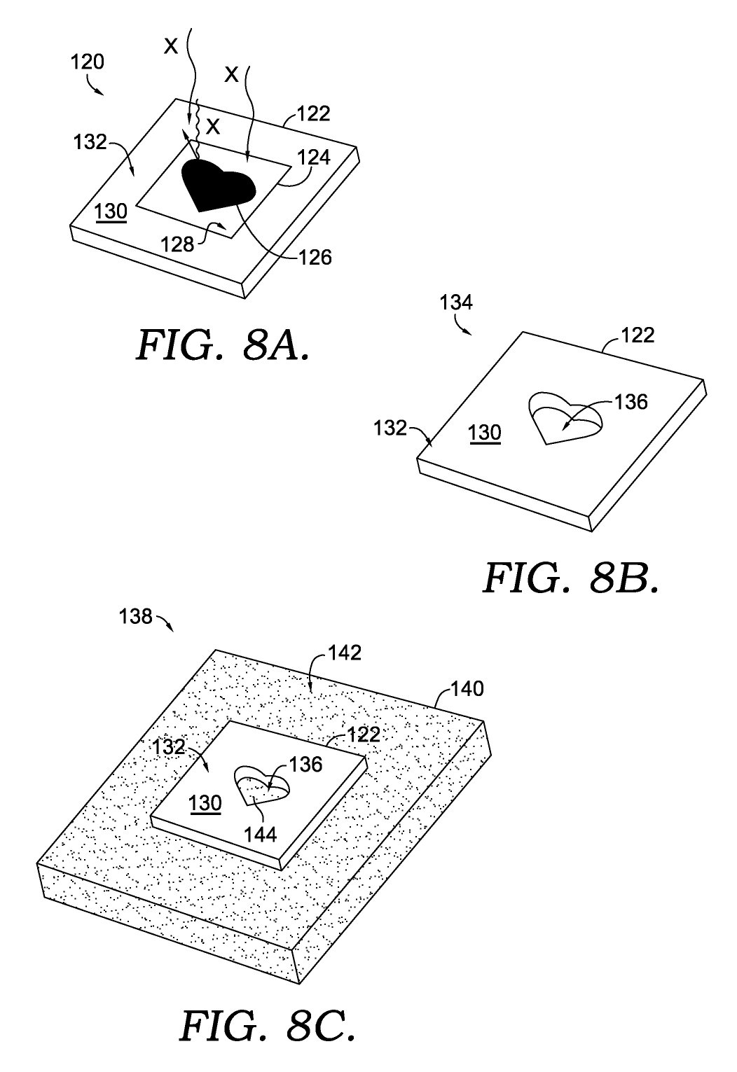

With reference to the example 94 of FIG. 7A, a perspective view of a rub-on transfer image 102 being applied to a porous plastic sheet 96 is depicted in accordance with an embodiment of the invention. In some aspects, the rub-on transfer image 102 (e.g., a heart) may be any image that is transferrable from a transfer sheet 100 onto a top surface 98 of a porous plastic sheet 96. As such, the rub-on transfer image 102 may be any image that produces a pattern for the handheld stamp, which may include positive or negative space for masking at least a portion of the top surface 98 of the porous plastic sheet 96. In one embodiment, a stylus 104 or other device is used, as shown in FIG. 7A, to apply pressure to the rub-on transfer image 102, thereby transferring at least a portion of the rub-on transfer image 102 from the transfer sheet 100 to the top surface 98 of the porous plastic sheet 96.

Accordingly, as shown in the perspective view 110 of FIG. 7B, the rub-on transfer image 102 from the transfer sheet 100 is now adhered to a top surface 98 of the porous plastic sheet, thereby creating a handheld stamp image 112 on the porous plastic sheet 96. In some aspects, the transferred rub-on transfer image 102 adheres to a top surface 98 of the porous plastic sheet 96 depicted in FIG. 7B such that ink flowing through the pores 108 of the porous plastic sheet 96 is blocked and/or masked where the rub-on transfer image 102 is applied. In the example of FIG. 7B, a negative image (i.e., handheld stamp image 112) of a heart is produced when ink applied to the porous plastic sheet 96 is stamped through the treated top surface 98 of the handheld stamp.

### Manual Marking on Porous Stamp Surface

In a further embodiment of the invention, a stamp image is created on a surface of a porous stamp surface, such as a porous plastic sheet, using a marking instrument that manually covers and/or clogs the pores of the porous stamp surface to produce a desired, masked stamp surface. For example, one method of making a handheld stamp includes applying a liquid and/or gel-like medium to the surface of a porous plastic sheet using a marking instrument that dispenses the liquid and/or gel-like medium. In one embodiment, the liquid and/or gel-like medium applied to the surface of the porous plastic sheet prohibits the flow of ink through the “marked” areas of the porous plastic sheet. In one embodiment, the pores of the porous plastic sheet that are exposed to the liquid/gel markings may be permanently or temporarily covered/clogged such that ink flowing through the porous plastic sheet is blocked on the portions of the porous plastic sheet having the markings. In a further embodiment, a handheld marker is used to apply a liquid and/or gel-like medium to a surface of a porous foam material, to create a handheld stamp. In embodiments, the pores of the porous foam material that are exposed to the marking liquid/gel-like medium may be permanently or temporarily covered/clogged such that ink flowing through the porous plastic sheet is blocked on the portions of the front surface having the markings.

With reference to FIG. 7C, a perspective view 114 of a marking instrument 116 applying a manual mask to the top surface 98 of a porous stamp surface is provided in accordance with an embodiment of the invention. The porous stamp surface, such as a porous plastic sheet 96, receives a manual marking 118 from a marking instrument 116 that covers and/or clogs a portion of the pores 108 of the exemplary porous stamp surface of FIG. 7C. As such, in some aspects, the areas left unmarked by the marking instrument 118 permit the flow of an ink solution dispensed through the top surface 98. In one embodiment, the marking instrument 116 is used to manually mask portions of the porous stamp surface, providing a handheld stamp for reproducing a stamped image of the unmasked portions of the stamp.

### Photosensitive Transfer and Porous Plastic Stamp

In a further embodiment of the invention, a handheld stamp is created using a transparency that masks a portion of a photosensitive transfer material during light treatment to produce a stamp mask. The stamp mask is then applied to a porous plastic stamping material to produce a handheld stamp. In one embodiment, a transparency is overlaid on a photosensitive transfer material that is exposed to light using a light-emitting device, as discussed above. The exposed and/or reacted portions of the photosensitive transfer material remain intact, while the unexposed portions of the photosensitive transfer material are washed away. In further embodiments, the photosensitive transfer material is applied to a porous plastic stamping material to produce a handheld stamp. For example, the photosensitive transfer material, at least a portion of which is removed based on light exposure around a stamp image transparency, is applied as a mask on a surface of a porous plastic stamping material.

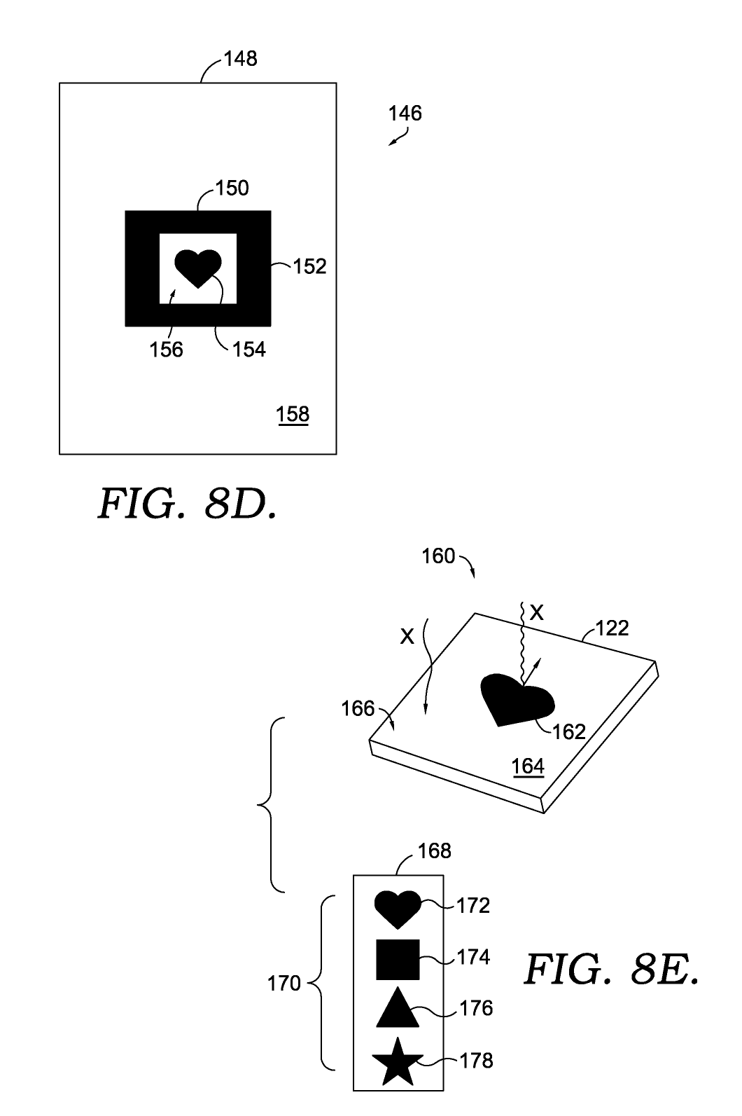

Accordingly, in the example 120 of FIG. 8A, a perspective view of a transparency 124 masking a photosensitive transfer material 122 is provided in accordance with aspects of the disclosure. The photosensitive transfer material 122 may be at least partially covered by the transparency 124 having a stamp image 126 (e.g., a heart) that blocks light X received on the top surface 130 of the photosensitive transfer material 122. As shown in FIG. 8A, the transparency 124 is configured to receive light X where the stamp image 126 is not masking the top surface 130 of the photosensitive transfer material 122, and all exposed areas of the photosensitive transfer material 122 are thereby “treated” with light X. For example, the exposed portions of the top surface 130 may include at least a portion of the exposed transfer material 132, as well as the visible portions 128 of the photosensitive transfer material 122 viewed through the unmarked portions of the transparency 124.

In the example 134 of FIG. 8B, the photosensitive transfer material 122 has been washed to remove the unexposed areas that were masked by the stamp image 126 in FIG. 8A. In one aspect, the photosensitive transfer material 122 is a photosensitive gel that hardens and/or cures when exposed to light X and remains pliable and/or removable where not exposed to light X. As such, the exposed portions of the photosensitive transfer material 122 (i.e. those corresponding to the visible portions 128 through the transparency 124, and the surrounding exposed transfer material 132 outside the bounds of the transparency 124) may be hardened and/or cured based on light exposure, while the unexposed portion of the photosensitive transfer material 122 previously blocked by the stamp image 126 is washed away and/or removed. As such, in some aspects, a stamp opening 136 corresponding to the unexposed stamp image 126 may be created, and washed away from the remaining portion exposed to light.

In other aspects, the template created in FIG. 8B may be applied to a surface of a porous plastic stamp material 140, as in the example 138 of FIG. 8C, to produce a handheld stamp. As such, in one aspect, an uncured portion of the photosensitive transfer material is removed, based on not being exposed to light, while the rest of the pores 142 of the photosensitive transfer material 140 exposed to light is hardened and/cured to provide a mask 144. In some aspects, the mask 144 may be used to stamp an image corresponding to the stamp opening 136, which was created based on the removed portions of the photosensitive transfer material 122. With reference to the example 146 of FIG. 8D, a top surface 158 of a drawing sheet 148 may receive a marking 150 having an outer portion 152 corresponding to an exposed surface of the porous plastic stamp material 140 (of FIG. 8C), an inner portion 154 corresponding to an exposed surface through stamp opening 136, and a masked portion 156 where ink is blocked by mask 144 during stamping.

Turning now to the example 160 of FIG. 8E, a sheet 168 of stamp images 170 may be provided, including one or more shapes and/or images for creating a handheld stamp. For example, the sheet 18 may include a first stamp image 172, a second stamp image 174, a third stamp image 176, and a fourth stamp image 178. In one example, one or more of the first, second, third, and fourth stamp images 172, 174, 176, and 178 may be an adhesive stamp for applying to a portion of a photosensitive transfer material, a photosensitive gel, a porous stamp surface, a porous plastic sheet, a photosensitive stamp body, a photosensitive stamp surface, and/or other material for creating a handheld stamp. For example, a first stamp image 172 may be applied to a top surface 164 of a photosensitive transfer material 122 to provide a masked image 162 on the top surface 164. When exposed to light X, the masked image 162 may reflect light X, while the exposed portions 166 of the top surface 164 may be treated and/or cured by the light X. In one example, the photosensitive transfer material 122 of FIG. 8E may be a photosensitive gel that hardens and/or cures where exposed to light, and a portion of the gel protected by the masked image 162 is washed away to provide an opening for stamping. In another example, the photosensitive transfer material 122 is a porous photosensitive stamp surface, with pores that close when exposed to light (exposed portions 166) and pores that remain open and allow the flow of ink for stamping when protected from light exposure (masked image 162). As such, in one aspect of the invention, one or more adhesive stamp images may be provided to adhere and/or couple to a top surface 164 of a photosensitive transfer material 122 for creating a handheld stamp.

### Stamp-Making Kit

In some aspects, a kit may be provided that includes one or more components for making a handheld stamp, such as a kit including one or more photosensitive stamp surfaces, one or more stamp images for applying to the photosensitive stamp surfaces, and/or a light-emitting device for preparing the stamp from the photosensitive stamp surface. In one example, a stamp-making kit may include at least one photosensitive stamp surface (e.g., a photosensitive porous foam and/or photosensitive gel), a light-emitting device and/or component for use in conjunction with a light-emitting device, and at least one masking feature for masking at least a portion of the photosensitive stamp surface during application of light from the light-emitting device (e.g., a stamp image for preventing light from contacting a portion of the stamp surface, such as a transparency, a mask, a rub-on transfer image, a sticker transfer image, a marking tool for manually applying a mask to the photosensitive stamp surface, a combination of features for creating a masked portion of the stamp surface, and the like.

Many different arrangements of the various components depicted, as well as components not shown, are possible without departing from the scope of the claims below. Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. A method of producing a handheld stamp comprising:
applying a stamp image mask to a top surface of a photosensitive stamp surface to provide a masked portion of the photosensitive stamp surface and an unmasked portion of the photosensitive stamp surface;
exposing the unmasked portion of the photosensitive stamp surface to light having a particular wavelength for a particular amount of time to provide a cured portion of the photosensitive stamp surface corresponding to the unmasked portion;
assembling the photosensitive stamp surface into a stamp housing comprising an ink reservoir; and
applying an ink solution from the ink reservoir to the photosensitive stamp surface to provide a handheld stamp configured to mark a stamp image corresponding to the masked portion of the photosensitive stamp surface.

2. The method of claim 1, wherein exposing the unmasked portion to light having a particular wavelength comprises exposing the unmasked portion of the photosensitive stamp surface to a light source emitting light having a threshold range of wavelength.

3. The method of claim 1, wherein exposing the unmasked portion of the photosensitive stamp surface for a particular amount of time comprises exposing the unmasked portion of the photosensitive stamp surface to a light source emitting light for a threshold amount of time.

4. The method of claim 3, wherein providing a cured portion of the photosensitive stamp surface comprises exposing the unmasked portion of the photosensitive stamp surface to light emitted from a light source for a threshold amount of time needed to close the pores of the unmasked portions of the photosensitive stamp surface.

5. The method of claim 1, wherein assembling the photosensitive stamp surface into a stamp housing comprises securing the photosensitive stamp surface with respect to the stamp housing such that the top surface of the photosensitive stamp surface is exposed and a bottom surface of the photosensitive stamp surface is adjacent at least a portion of the ink reservoir.

6. The method of claim 1, wherein applying an ink solution from the ink reservoir to the photosensitive stamp surface to provide a handheld stamp configured to mark a stamp image corresponding to the masked portion of the photosensitive stamp surface comprises transferring an amount of ink solution from the ink reservoir through one or more open pores of the photosensitive stamp surface corresponding to the masked portion of the photosensitive stamp surface.

7. A handheld stamp comprising:
a porous plastic sheet having a first surface and a second surface; and
a rub-on transfer image for application to the first surface of the porous plastic sheet,
wherein application of the rub-on transfer image to the first surface of the porous plastic sheet provides a masked portion of the porous plastic sheet and an unmasked portion of the porous plastic sheet, wherein the unmasked portion of the porous plastic sheet permits a flow of an ink solution through the porous plastic sheet, and
further wherein the handheld stamp is configured to stamp an image corresponding to the unmasked portion of the porous plastic sheet based on application of the ink solution traveling from the second surface of the porous plastic sheet to the first surface of the porous plastic sheet.

8. The handheld stamp of claim 7, wherein upon application of the rub-on transfer image to the first surface of the porous plastic sheet, at least one pore on a surface of the porous plastic sheet is configured to prevent the flow of an ink solution through at least a portion of the porous plastic sheet in response to contact with the rub-on transfer image.

9. The handheld stamp of claim 8, wherein upon application of the rub-on transfer image to the first surface of the porous plastic sheet, a plurality of pores corresponding to the rub-on transfer image are configured to prevent the flow of an ink solution through at least a portion of the porous plastic sheet in a shape corresponding to a shape of the rub-on transfer image.

10. The handheld stamp of claim 8, wherein the rub-on transfer image comprises a rub-on marking material applied manually using a marking device.

11. The handheld stamp of claim 7, wherein stamping an image corresponding to the unmasked portion of the porous plastic sheet comprises applying an ink solution to a drawing surface via the unmasked portions of the porous plastic sheet.

12. A method of making a handheld stamp, the method comprising:
applying a transparency mask to a photosensitive transfer material to provide a masked portion of a photosensitive transfer material and an unmasked portion of a photosensitive transfer material;
exposing the unmasked portion of the photosensitive transfer material to light for a threshold amount of time;
removing at least a portion of the masked portion of the photosensitive transfer material from the photosensitive transfer material to produce a stamp mask; and
applying the stamp mask to a porous stamping material to produce a handheld stamp, wherein the handheld stamp is configured to reproduce an image corresponding to the masked portion of the photosensitive transfer material removed from the stamp mask.

13. The method of claim 11, wherein removing at least a portion of the masked portion of the photosensitive transfer material comprises applying a rinsing solution to the photosensitive transfer material.

14. The method of claim 13, wherein the masked portion of the photosensitive transfer material is configured to separate from the masked portion of the photosensitive transfer material in response to exposure to the rinsing solution.

15. The method of claim 12, wherein applying the stamp mask to a porous stamping material to produce a handheld stamp comprises overlaying the stamp mask on a first surface of a porous stamping material.

16. The method of claim 15, wherein producing a handheld stamp comprises exposing a second surface of the porous stamping material to an amount of stamping ink solution, wherein at least a portion of the amount of stamping ink is transferred through the porous stamping material.

17. The method of claim 16, wherein producing a handheld stamp comprises assembling the stamp mask, the porous stamping material, the amount of stamping ink solution, and at least one housing configured to secure one or more of the stamp mask, the porous stamping material, and the amount of stamping ink solution.

18. The method of claim 12, wherein exposing the unmasked portion of the photosensitive transfer material to light for a threshold amount of time comprises exposing the photosensitive transfer material with the applied transparency mask to light for a threshold amount of time.

19. The method of claim 18, wherein in response to exposing the photosensitive transfer material with the applied transparency mask to light for a threshold amount of time, light is received by the unmasked portions of the photosensitive transfer material and light is blocked by the masked portions of the photosensitive transfer material.

20. The method of claim 12, wherein reproducing an image corresponding to the masked portion of the photosensitive transfer material comprises stamping an amount of ink passing through one or more portions of the stamp mask.
